(19) United States
(12) Patent Application Publication
(10) Pub. No.: US 2015/0028867 A1
(43) Pub. Date: Jan. 29, 2015

(54) METHOD AND SYSTEM FOR MEASURING RELATIVE VELOCITY BETWEEN A VEHICLE AND THE SURROUNDING ATMOSPHERE

(71) Applicant: Jutta Gaguen, Antibes (FR)

(72) Inventor: Carl Tyrén, Monaco (MC)

(21) Appl. No.: 14/360,246

(22) PCT Filed: Nov. 23, 2011
(86) PCT No.: PCT/SE2011/000211

§ 371 Date: Sep. 18, 2014

(51) Int. Cl. G01F 1/716; G01P 5/00

(52) U.S. Cl. CPC G01F 1/716; G01P 5/00
USPC 324/306

(57) ABSTRACT

A method and system for measuring a vehicle airspeed, wherein a nuclear magnetic resonance, NMR, measurement method is used for obtaining relative velocity between the vehicle and an atmosphere surrounding the vehicle. A groove is arranged at the outside body of an aircraft and the surrounding atmosphere is allowed to pass inside the groove. A strong magnet system establishes a magnetic field with a gradient in the flow direction. The atoms passing inside the groove is exposed to an electromagnetic radiation whereby the atoms oscillate at a Lamor frequency, which is proportional to the strong magnetic field. The change in Lamor frequency along the groove is measured and is proportional to the airspeed.

### FIELD OF INVENTION

The present invention relates to a method and a system for measuring relative velocity between a vehicle and the surrounding atmosphere, so called airspeed.

### BACKGROUND

One of the most important parameters of airborne vehicles is the relative velocity of the vehicle, such as an aircraft, relative to the ambient air, i.e. the airspeed.

Ground speed—the relative speed between the aircraft and the ground—can today readily be measured using GPS, Doppler, inertial or other means. The measurement of ground speed has become more and more accurate with the progress of the technology.

Airspeed may be of interest not only for airborne vehicles but also for land-based vehicles, such as a car, and floating vehicles, such as a ship.

The measurement of airborne vehicle airspeed is still done as it has been done since the early days of flight using a pitot tube to measure the difference between the total air pressure and the static air pressure rendering the dynamic air pressure, from which the airspeed can be calculated.

Today, aircrafts are predominantly flown without any direct mechanical link between the cockpit control input and the aircraft control surfaces. Instead electrical signal transfer the command signals, i.e. so-called Fly-by-Wire control. Lately, the distance between man and machine has been further increased by the continuously growing use of Fly-by-Computer control. This direct involvement of the computer in the flying control of the aircraft has dramatically increased the demand on correct flight data inputs to the computers.

The correct measurement of airspeed is of paramount importance for the safe control of flight and erroneous or lost airspeed data may be fatal. This fact has unfortunately been demonstrated by a number of aircraft catastrophes during recent years. A complete loss of aircraft control and fatal crashes have resulted from such failures as simply forgetting to remove pitot tube protective covers before start-up, frozen and clogged up pitot tube intakes, in spite of the fact that they are normally heated, to more complex air data failure modes.

Therefore, the need for a better and more reliable airspeed sensor is evident and of vital importance for increase of the mean time before failure, MTBF, of the complete aircraft.

In recent time, ash from volcanic eruptions has disturbed the aircraft flight. Thus, there is a demand for a sensor that can measure the presence of volcanic ash in an atmosphere surrounding an aircraft.

### SUMMARY OF THE INVENTION

Accordingly, an object of the present invention is to mitigate, alleviate or eliminate one or more of the above-identified deficiencies and disadvantages singly or in any combination.

In an aspect, there is provided a method of measuring a vehicle airspeed, wherein a nuclear magnetic resonance, NMR, measurement method is used for obtaining relative velocity between the vehicle and the atmosphere surrounding the vehicle.

The nuclear magnetic resonance measurement method may comprise the following step: a) establishing a magnetic field gradient in an area in which the atmosphere is passing the vehicle; b) measuring Larmor frequency changes in said magnetic field gradient; c) selecting the highest Larmor frequency changes, representative of hydrogen atom Larmor frequency changes; d) calculating hydrogen atom velocity from said Larmor frequency changes, whereby said hydrogen atom velocity is equal to said vehicle airspeed.

The measured Larmor frequencies may be analyzed for the composition of the surrounding atmosphere, such as substances indicating the presence of volcanic ash.

The nuclear magnetic resonance, NMR, measurement method may be combined with an Electron Magnetic Resonance, EMR, method.

In another aspect, there is provided a system for measuring a vehicle airspeed, comprising a nuclear magnetic resonance, NMR, system for obtaining relative velocity between the vehicle and an atmosphere surrounding the vehicle.

In an embodiment, the system may comprise a groove arranged at the outside body of the aircraft, whereby the surrounding atmosphere is allowed to pass inside the groove; a strong magnet system, which establishes a magnetic field with a gradient in the flow direction; a source of electromagnetic radiation, whereby the atoms passing inside the groove is exposed to said electromagnetic radiation resulting in that the atoms oscillates at a Lamor frequency, which is proportional to the strong magnetic field; a measurement sensor for measuring the Larmor frequency, which is proportional to the airspeed.

In a further embodiment, there may be arranged a nozzle before the groove in the flow direction for ejecting a gas, such as methane gas.

In a further aspect, there is provided a use of a nuclear magnetic resonance, NMR, measurement method for obtaining relative velocity between a vehicle and an atmosphere surrounding the vehicle for measuring the vehicle airspeed.

### BRIEF DESCRIPTION OF THE DRAWINGS

Further objects, features and advantages of the invention will become apparent from the following detailed description of embodiments of the invention with reference to the drawings, in which:

FIG. 1 is a partial side view of an aircraft provided with an embodiment of the airspeed sensor.

FIG. 2 is a side view partially in cross-section of the embodiment shown in FIG. 1.

FIG. 3 is plan view of the embodiment shown in FIG. 1.

FIG. 4 is a front view of the embodiment shown in FIG. 1.

### DETAILED DESCRIPTION OF EMBODIMENTS

Below, several embodiments of the invention will be described. These embodiments are described in illustrating purpose in order to enable a skilled person to carry out the invention and to disclose the best mode. However, such embodiments do not limit the scope of the invention. Moreover, certain combinations of features are shown and discussed. However, other combinations of the different features are possible within the scope of the invention.

Nuclear Magnetic Resonance, NMR, is used as a method for medical imaging. NMR is used for example for scientific as well as engineering applications.

Another application of NMR, much less known, is the measurement of flow velocities. With this technique very demanding flow measurement tasks can be solved.

NMR flow sensing is a non-contacting and non-invasive method that uses a combination of magnetic fields and electromagnetic fields to detect fluid flow.

The basis of all NMR analysis is the relation between magnetic field intensity, B, and atom spin resonance frequency, ω, the so-called Larmor frequency. The Larmor equation is:

ω=−γB

Determined by a physical constant, γ, the Larmor frequency, ω, is an exact measure of the ambient magnetic field intensity, B. This fact is for instance used in very sensitive magnetometers for geological and military applications capable o resolving 10̂-9 magnetic field intensity fluctuations.

NMR may also be used for measuring flow velocity of a substance. There are several methods known for different applications. One method is to apply a magnetic field gradient along the flow path. When a hydrogen atom moves through the field gradient, i.e. through a changing magnetic field intensity, the hydrogen atom Larmor frequency will change accordingly. The rate of Larmor frequency change is directly proportional to the velocity of the hydrogen atom through the magnetic gradient field section. This method has been used for simultaneous measurement of multi-phase mass flows, such as mixtures of gas and liquid flows in an oil-well pumping tube, which is virtually impossible to measure with any other conventional flow measurement technique. This method has not been used before for measuring airspeed of an aircraft.

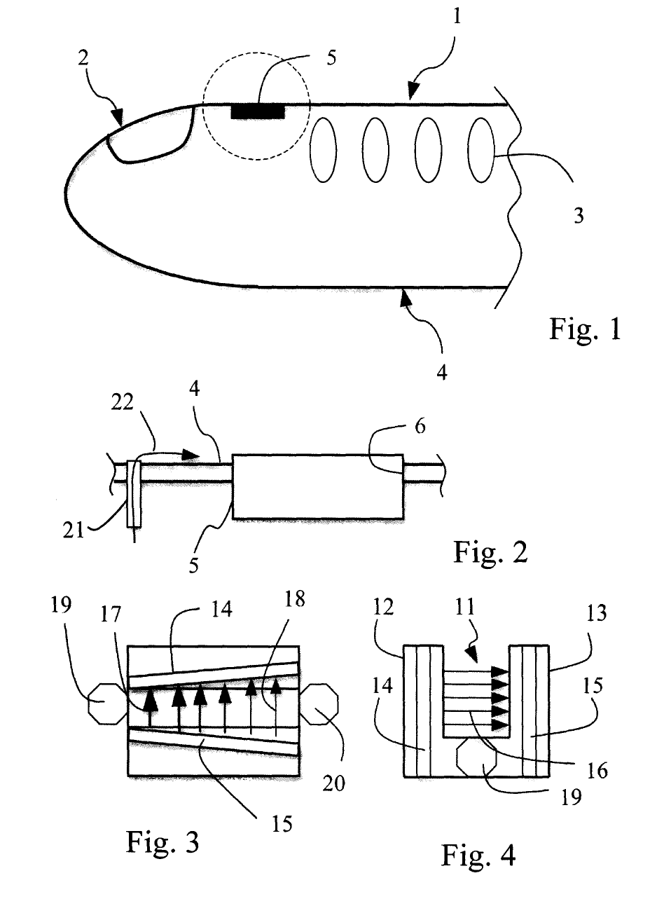

FIG. 1 is a side view of an aircraft 1, having a cockpit 2 and several windows 3 arranged in a body 4 of the aircraft. An airspeed sensor 5 is arrange adjacent the cockpit 2 in an opening 6 of the body 4 of the aircraft, as shown in FIG. 2.

The airspeed sensor is seen from above in FIG. 3, i.e. in a plan view, and from the front in FIG. 4. The airspeed sensor has a deep groove 11 surrounded by sidewalls 12 and 13. The groove 11 is directed in the flow direction of the aircraft so that the surrounding air can flow through the groove 11. The bottom of the groove is substantially flush with the outside surface of the body of the airplane and the sidewalls extend a specific distance there above, such as 5 cm. The length of the sidewalls may be 10 cm. Other dimensions may be used.

Each sidewall comprises a strong permanent magnet 14, 15. The magnets form a strong magnetic field as shown by arrows 16 in FIG. 4. As shown in FIG. 3, the magnets 14 and 15 are arranged at an angle. By this arrangement, there is formed a magnetic field which is strongest to the left in FIG. 3 and decreases along the length of the airspeed sensor. This fact is further shown by the thick arrow 17 to the left and the thin arrow 18 to the right in FIG. 3. Thus, air entering the groove 11 from the left in FIG. 3 passes through a strong magnetic field in the beginning of the groove and the magnetic field decreases as the air moves along the groove to the right in FIG. 3. However, the physical sidewalls are parallel.

FIG. 4 shows an electromagnetic energizer 19, which is arranged adjacent the entrance as shown schematically to the left in FIG. 3. The energizer is arranged to emit a short pulse or burst of electromagnetic radiation, which comprises several frequencies around the resonance frequency of the atoms comprised in the air passing in the groove. The energizer activates the atoms in the air. The atoms are allowed to absorb energy and in order to revers the spin direction of the atoms.

Several sensors 20 are arranged along the groove, of which one sensor 20 is shown in FIG. 3 to the right of the groove. However, further sensors are arranged along the length of the groove. The sensors are arranged to detect radio frequency emissions from the atoms passing along the groove, when the atoms revert to the original spin direction.

Since the atoms are passing along a decreasing magnetic field, the Larmor frequency emitted and absorbed by the atoms will decrease as the atoms passes along the groove. Suppose that the magnetic field strength B=2.36 T at the beginning of the groove and decreases to half, i.e. B=1.18 T at the end of the groove, then hydrogen atoms will emit a Larmor frequency of 100 MHz at the start of the groove and 50 MHz at the end of the groove. If the groove has a length of 10 cm and the airspeed is 100 msec, the time it takes for an atom to pass through the groove is 100 μs. Thus, the decrease of the Larmor frequency will be 50 HMz during 100 μs, or 0.50 MHz per microsecond. If the airspeed is 200 msec, the decrease will be 1.00 MHz per microsecond etc. By measuring the Larmor frequencies at regular intervals, for example each microsecond, the speed of the atom can be calculated.

The measurement cycle is repeated at regular intervals.

The air surrounding the aircraft normally comprises water vapor, which comprises hydrogen atoms and oxygen atoms. However, the oxygen atoms will only contribute with a small amount, since the Larmor frequency of the oxygen atom is much smaller.

In addition, the surrounding atmosphere may comprise water, snow and ice.

The constant in the Larmour frequency equation, γ, is different for different substances. For a magnetic field strength B=2.349 T, the Larmor frequency for the following substances are: ¹H—100.0 MHz; ¹³C—25.15 MHz; ¹⁴N—7.227 MHz, ¹⁵N—10.14 MHz; ¹⁷O—13.56 MHz; ²⁷Al—26.07 MHz; ²⁹Si—19.85 MHz; ³¹P—40.49 MHz; etc.

This fact may be used for measurement of the composition of a fluid. Thus, a computer may analyze the different Larmor frequencies measured and calculate a composition of the atmosphere surrounding the aircraft.

In certain situations, there may be a lack of hydrogen atoms in the atmosphere surrounding the aircraft. In this situation, there may be arranged a nozzle 21 in front of the airspeed sensor. The nozzle 21 is arranged to emit a gas as shown by arrow 22. The gas passes to the airspeed sensor. The gas may be arranged to comprise hydrogen atoms. A suitable gas may be methane gas. Thus, it is ensured that hydrogen atoms pass the airspeed sensor at substantially the speed of the surrounding atmosphere.

There may be arranged a safety airspeed sensor, which is arranged to measure the time it takes for the emitted methane gas to reach the airspeed sensor. Since the distance is known, the approximate airspeed can be calculated. This airspeed measurement can be used for validating that the airspeed sensor operates correctly.

It may be desired to detect if volcanic ash is present in the air surrounding the aircraft. Volcanic ash almost always contains Si, Al, K, Na, Ca, Mg and/or Fe. Thus, the presence of for example Silicon, Si, may be detected by looking for a resonant frequency, which is about 19.85% of the highest resonant frequency, whereby the highest resonant frequency is the resonant frequency of the hydrogen atom. Silicon is not normally present in the atmosphere at an altitude corresponding the flight height of an aircraft. Thus, if Silicon is detected, this may be an indication of volcanic ash in the air.

The disclosed embodiment of the airspeed sensor is insensitive to build up of ice or dirt on the aircraft body surface and inside the groove. Anyhow, it may be desired to arrange that the groove is heated continuously or intermittently for removing ice.

There are several known methods of arranging a nuclear magnetic resonance system for measuring fluid flow, see for example the following patent specifications: U.S. Pat. No. 4,110,680A; U.S. Pat. No. 4,248,085A; U.S. Pat. No. 4,531,093A; U.S. Pat. No. 4,536,711A; U.S. Pat. No. 4,574,240A; U.S. Pat. No. 4,621,234A; U.S. Pat. No. 4,901,018A; U.S. Pat. No. 5,093,619A; US2007164737A1; EP1664688A1; EP0691526A1; EP0496330A2.

The airspeed sensor is shown in relation to a NMR measurement method. The NMR method may also be combined and/or replaced with an Electron Magnetic Resonance, EMR, method.

The shown embodiment may be arranged in different manners. For example, the permanent magnets may be replaced by electromagnets.

The permanent magnets may be Neodymium-Iron-Bohron magnets.

The RF magnetic system may be applied as a flush electrical conductors film segment on the outside skin surface of the airborne vehicle.

Alternatively, the RF magnetic system is attached as elements on the outside of the air vehicle external skin.

The airspeed sensor may be arranged on an airborne vehicle, such as an aircraft. However, the airspeed sensor may be used for measuring airspeed in any application, such as wind velocity in a land-based arrangement or at a floating vehicle, such as a ship.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims or embodiments, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Although the present invention has been described above with reference to specific embodiment and experiments, it is not intended to be limited to the specific form set forth herein. Rather, the invention is limited only by the accompanying claims and, other embodiments than those specified above are equally possible within the scope of these appended claims.

1. A method of measuring a vehicle airspeed, wherein a nuclear magnetic resonance, NMR, measurement method is used for obtaining relative velocity between the vehicle and an atmosphere surrounding the vehicle.

2. The method according to claim 1, comprising the following step:
a) establishing a magnetic field gradient in an area in which the atmosphere is passing the vehicle;
b) measuring Larmor frequency changes in said magnetic field gradient;
c) selecting the highest Larmor frequency changes, representative of hydrogen atom Larmor frequency changes;
d) calculating hydrogen atom velocity from said Larmor frequency changes, whereby said hydrogen atom velocity is equal to said vehicle airspeed.

3. The method according to claim 1, wherein the measured Larmor frequencies are analyzed for the composition of the surrounding atmosphere.

4. The method according to claim 1, wherein the nuclear magnetic resonance, NMR, measurement method is combined with an Electron Magnetic Resonance, EMR, method.

5. A system for measuring a vehicle airspeed, comprising a nuclear magnetic resonance, NMR, system for obtaining relative velocity between the vehicle and an atmosphere surrounding the vehicle.

6. The system according to claim 5, comprising
a groove arranged at the outside body of the aircraft, whereby the surrounding atmosphere is allowed to pass inside the groove;
a strong magnet system, which establishes a strong magnetic field with a gradient in the flow direction;
a source of electromagnetic radiation, whereby the atoms passing inside the groove is exposed to said electromagnetic radiation resulting in that the atoms oscillates at a Lamor frequency, which is proportional to the strong magnetic field;
a measurement sensor for measuring the Larmor frequency, which is proportional to the airspeed.

7. The system according to claim 6, wherein a nozzle is arranged before the groove in the flow direction for ejecting a gas, such as methane gas.

8. (canceled)

9. A method of analyzing the surrounding atmosphere of a vehicle of occurrence of substances, comprising the following step:
a) establishing a magnetic field gradient in an area in which the atmosphere is passing the vehicle;
b) exposing atoms passing in said magnetic field gradient for electromagnetic radiation resulting in that the atoms oscillates at a Lamor frequency, which is proportional to the magnetic field;
c) measuring Larmor frequency changes in said magnetic field gradient;
d) analyzing the Larmor frequency changes for analyzing substances present in the surrounding atmosphere.

10. The method according to claim 9, wherein said substances analyzed comprises volcanic ash.

11. The method according to claim 9, wherein said substances analyzed comprises volcanic ash and hydrogen atoms.

12. The method according to claim 9, further comprising calculating atom velocity from said Larmor frequency changes, whereby said atom velocity is equal to said vehicle airspeed.

13. The method according to claim 12, wherein said atom velocity is equal to hydrogen atom velocity.
